(19) United States
(12) Patent Application Publication
(10) Pub. No.: US 2011/0087582 A1
(43) Pub. Date: Apr. 14, 2011

(54) METHOD AND SYSTEM FOR FACILITATING INTERNATIONAL SECURITIES TRADING

(75) Inventors: James S. PAK, Essex Fells, NJ (US); Matthew N. TRUDEAU, New York, NY (US)

(73) Assignee: INSTINET, INC., New York, NY (US)

(21) Appl. No.: 12/894,445

(22) Filed: Sep. 30, 2010

Related U.S. Application Data
(60) Provisional application No. 61/278,630, filed on Oct. 9, 2009.

(51) Int. Cl. G06Q 40/00

(52) U.S. Cl. 705/37

(57) ABSTRACT

A method and a system for facilitating international securities trading include receiving market data specified in the local currency of a market center. The system includes a central platform that provides foreign executable currency quotes, which can be used to convert the market center's central limit order book into multiple foreign currencies. Orders specified in a foreign currency are converted to the local currency and placed with the market center. When two orders are matched, the system handles execution of a foreign exchange (FX) portion of the order based on the best FX quote provided by an FX liquidity provider, locked in at the time of receipt of the order.

### CROSS-REFERENCE TO RELATED APPLICATION

This application claims the benefit, under 35 U.S.C. §119(e), of U.S. Provisional Patent Application Ser. No. 61/278,630 filed Oct. 9, 2009, the disclosure of which is herein incorporated by reference in its entirety.

### FIELD OF THE INVENTION

The present invention relates to methods and systems for facilitating international securities trading, for example, that involves the buying and selling of shares of foreign securities not available on local markets.

### BACKGROUND INFORMATION

Investors often trade locally by buying and selling domestic securities, e.g., a United States (U.S.) investor that trades shares of U.S. based publicly traded companies. Some investors also invest in foreign companies. Traditionally, the methods by which investors are able to invest in foreign securities have been limited and have certain disadvantages. One method, in the U.S. for example, involves trading in American Depository Receipts (ADRs), instead of in the shares of the foreign securities themselves. The ADRs are local representations of ownership in shares of the foreign securities. ADRs are traded locally in the U.S. Because trading is domestic, transactions in the U.S. are specified in U.S. dollar amounts, and are often priced with a mark-up, e.g., because of broker fees, differences in tax rates, execution and clearing costs, etc. Thus, the relative cost of purchasing or selling shares in the U.S. may be higher compared to performing an equivalent transaction locally in the foreign country.

Another method of foreign securities trading is to trade securities via a foreign broker. For example, a U.S. investor can place an order with a U.S. broker, who communicates with a foreign counter-part broker. The foreign broker will convey the order to the foreign securities exchange, e.g., a foreign stock exchange, and confirm the order with the U.S. broker. In addition to the placing of the order at the foreign exchange, a second transaction must also be conducted. The order, when placed by the U.S. investor, will typically be specified by a U.S. dollar amount or by a specified share number. For example, the investor may request to purchase $1,000 worth of shares or, alternatively, 100 shares in X corporation. The second transaction involves a conversion of U.S. dollars (USDs) to the foreign currency, e.g., Canadian Dollars (CAD), through a foreign exchange (FX) dealer.

Several problems exist with the second method as well. First, the U.S. investor must rely on the FX dealer, who will only perform the conversion in return for a fee. Second, the need to perform two separate transactions presents timing problems, depending on the order in which the transactions are done. Typically, the equity order is first placed and executed with the foreign exchange. Following order execution, e.g., a few minutes after execution, later in the day, or at the end of the day, the FX conversion transaction occurs. Between the time the equity order is executed and the FX conversion, the FX rate is subject to change. Thus, the investor is subject to risk exposure because the investor is unable to anticipate how much the investor will ultimately pay for buying shares or the dollar amount the investor will get in return for selling shares. Third, U.S. investors are generally accustomed to thinking and planning investments in terms of USDs rather than in terms of foreign currencies. Even with a knowledge of the most recent exchange rates, constantly converting USDs to foreign currencies can be burdensome, particularly if the investor is investing in multiple markets, each with a different currency. Fourth, the investor's security broker/dealer may undertake efforts to locate and compare FX rates from multiple sources to seek out the most advantageous prevailing FX rate, or must rely on a single FX dealer and pay the rate the dealer charges, even if it is not the most advantageous prevailing rate.

It is therefore apparent that a need exists for a way to enable trading of foreign securities without the disadvantages and inefficiencies of the methods described above. The present invention overcomes current inefficiencies and disadvantages, and provides greater price transparency, thereby enabling market centers to capture incremental equity (or other asset class, such as equity options, futures, etc.) order flow from international participants, e.g., U.S. investors, and attract increased activity from participants such as FX liquidity providers and brokers. While example embodiments of the present invention are described with respect to an equity order flow, the invention may be similarly applied to other asset classes, such as equity options, futures, etc.

### BRIEF DESCRIPTION OF THE DRAWINGS

FIG. 1 is a block diagram that shows an arrangement for facilitating international securities trading according to an example embodiment of the present invention.

FIG. 2 is a flowchart that shows a method for providing synthetic quotes in international securities trading according to an example embodiment of the present invention.

FIG. 3 shows data processed in accordance with the method of FIG. 2.

FIG. 4 is a flowchart that shows a method for facilitating international securities trading according to an example embodiment of the present invention.

FIG. 5 shows a block diagram of a central platform according to an example embodiment of the present invention.

### SUMMARY

According to example embodiments of the present invention, a computer-implemented method for facilitating securities trading includes one or more computer processors performing the following: obtaining market data including at least one price quote expressed according to a first currency; obtaining an exchange rate quote for converting a number of units of the first currency into a number of units of a second currency; based on the exchange rate quote, modifying the price quote for expression according to the second currency; and transmitting the modified price quote for output at an investor terminal.

In an example embodiment of the present invention, the method further provides that, responsive to the receipt of an order, the one or more computer processors utilize the obtained exchange rate quote or a new exchange rate quote for a pendency of the order.

According to example embodiments of the present invention, a computer-implemented method for facilitating securities trading includes one or more computer processors performing the following: receiving an exchange rate quote for converting a number of units of a first currency into a number of units of a second currency, while the received exchange rate quote is open, receiving an order specifying value units expressed according to one of the first and second currencies; and responsive to receipt of the order: utilizing the exchange rate quote for the pendency of the order; converting the received order into a modified order specifying value units expressed according to the other of the first and second currencies; and transmitting the modified order for execution.

According to example embodiments of the present invention, a computer-implemented method and a corresponding system for facilitating international securities trading includes at least one computer processor performing the following: receiving market data from a local market center, the market data including a bid price and an offer price of an order at the local market center, the prices being specified using a local currency; receiving at least one foreign exchange (FX) quote from at least one FX liquidity provider (LP), each FX quote having a buy rate and a sell rate for converting between the local currency and a foreign currency; generating a synthetic order book by converting the bid prices into the foreign currency using a best available buy late and converting the offer prices into the foreign currency using a best available sell rate, such that the synthetic order book has the bids and offers of the order book as modified by the best available buys and sells, respectively, of the FX currency quotes; and transmitting a synthetic quote to a foreign investor. The synthetic quote may be a best bid/offer or lower level quote (depth of book). For example, the quote may be of the best bid and offer quotes of the synthetic order book, or may include lower level quotes as well, e.g., the entire synthetic order book.

In an example embodiment of the present invention, the at least one computer processor also: receives a securities order provided on behalf of the foreign investor, the securities order being specified using the foreign currency; responsive to receiving the securities order, utilizes an FX quote having a buy/sell rate determined to be the best available rate at the time the securities order is received; converts the securities order into the local currency based on the utilized FX quote; transmits the converted securities order to the local market center; and responsive to receiving an indication of successful execution of the order, transmits an execution report for the security and an execution report for the FX transaction.

In an example embodiment of the present invention, the at least one computer processor is located on a central computer, which is communicatively coupled to the FX LP and the local market center.

In an example embodiment of the present invention, steps performed by the at least one computer processor are performed in accordance with a set of processor-executable instructions contained in a hardware-implemented computer-readable storage medium.

### DETAILED DESCRIPTION

Example embodiments of the present invention relate to a method and a corresponding system for facilitating international securities trading. In an example embodiment of the present invention, the system includes a central platform configured to accept international securities orders from investors foreign to the exchange, e.g., U.S.-based investors. The central platform is further configured to function as an intermediary in the processing of both an FX transaction component and an equity transaction component of the international orders. In this manner, the central platform provides a trading arrangement whereby all the relevant parties to a securities order are brought together in a price-transparent and competitive environment.

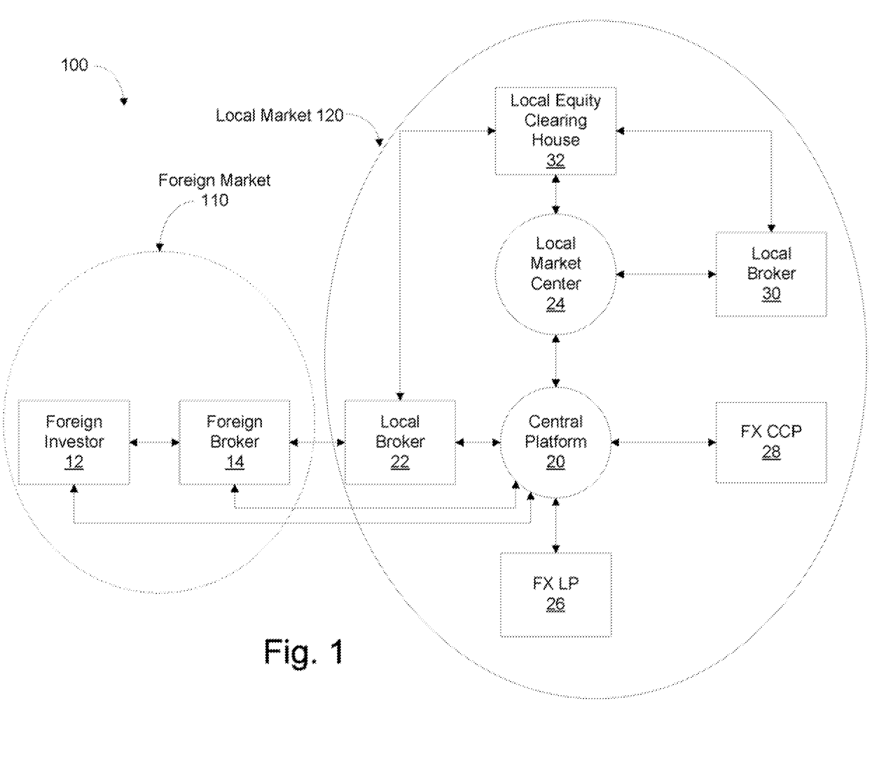

FIG. 1 shows an arrangement 100 for facilitating international securities trading according to an example embodiment of the present invention. The arrangement 100 may include a foreign market 110 and a local market 120. As used hereinafter, the term “local” refers to any system component participating in the same market as the central platform 20, and the term “foreign” refers to any system component participating in a market outside of those in which the central platform 20 participates. It should be noted, however, that these terms are merely conceptual divisions and the various system components may be physically located anywhere. Therefore, a local component need not be geographically located in the same region as other local components. Similarly, foreign components need not be co-located.

Reference will be made to system components that are in communication with one another. It will be understood that any form of communication may be utilized. For example, communication may be conducted over wired or wireless computer networks such as the Internet, via facsimile, via telephone, etc. Thus, the present invention may be implemented using any number of conventional communication technologies.

The foreign market 110 may be, for example, a U.S. (or other) market including a foreign investor 12 in communication with a foreign broker 14. The investor 12 may be an individual or institutional investor participating in the trading of U.S. securities, e.g., buying and selling shares of publicly traded U.S. companies. The foreign broker 14 may be any securities broker authorized to perform brokerage services for the foreign market 110.

Conventionally, if the investor 12 desires to trade in the securities of another market, e.g., buying and selling shares of companies denominated in foreign currency, the investor 12 must place an order with the foreign broker 14, who then relays the order to a local broker. In turn, the local broker performs two separate transactions. For a first one of the transactions, i.e., an equity transaction, the local broker initially obtains an FX quote from an FX dealer in order to convert the order from a foreign currency, e.g., USDs, to a local currency, e.g., Canadian Dollars (CADs). In reliance upon the FX quote and corresponding converted price, the local broker performs the first transaction, i.e., the equity transaction, by placing the order with the local market center. After the order has executed, the local broker then completes the second transaction, i.e., an FX transaction, by obtaining a final order price from the FX dealer, who calculates the final order, price based on prevailing exchange rates, which may not be the same as the rates on which the initial FX quote was based. The final order price typically includes a markup and is calculated at predetermined time intervals, such as the end of the day or several times a day. Alternatively, instead of reliance on the foreign broker 14 to process the FX transaction, the investor 12 relies on the custodian bank of the investor 12 to process the FX at the end of the day.

In contrast, referring to FIG. 1, an example embodiment of the present invention provides a central platform 20 included in the local market 120. The local market 120 may further include a local broker 22, a local market center 24, an FX LP 26, an FX central counter party (CCP) 28, a local broker 30, and a local equity clearing house 32. The local broker 30 and the local equity clearing house 32 refer to typical components of local markets. For example, the local broker 30 may be authorized to perform brokerage services concerning trading on the local market center 24. The local broker 30 is in communication with the local equity clearing house 32 and the local market center 24, which is also in communication with the local equity clearing house 32. To facilitate communication, the central platform 20 may be deployed in the same geographic region as the local market center 24. However, in an alternative embodiment, the central platform 20 may be located in a different geographic region from that of the local market center 24.

The local market center 24 may be any trading facility configured to accept securities orders. In an example embodiment, the local market center 24 is an Alternative Trading System, e.g., Chi-X Canada, a trading facility in which shares of Canadian companies are publicly traded using Canadian local currency, i.e., CADs.

The local equity clearing house 32 may be configured to provide clearing and settlement services on behalf of parties participating in equity orders. The local equity clearing house 32 may receive indications of order execution from the local market center 24, as well as to receive confirmation information such as order volume and price, from local brokers who participate in the executed equity orders. After verification of order volume and price, the local equity clearing house 32 may receive funds and/or other assets from the parties participating in the equity order, e.g., the local broker 30 and a counterparty broker, and distribute the funds or assets, thereby performing settlement between the parties.

Orders originating from local investors are placed with the local broker 30, who communicates the order to the local market center 24, where the order is matched to another order existing in a central limit order book of the local market center 24, i.e., matching a buy order to a sell order. The local broker 30 also communicates the order to the local equity clearing house 32. For example, if the order is a sell order, the local broker 30 may indicate to the local equity clearing house 32 the number of shares sold so that the order may be settled after the local market center 24 has notified the local equity clearing house 32 of order execution.

As shown in FIG. 1, on the local side, the central platform 20 is in communication with the local market center 24, the local broker 22, the FX LP 26 and the FX CCP 28. On the foreign side, the central platform 20 is in communication with both the investor 12 and the foreign broker 14. The central platform 20 may be implemented on a computer or network of computers using any combination of hardware and/or software. For example, the central platform 20 may include a software engine which controls a plurality of hardware and/or software communication ports, through which the central platform 20 communicates with other system components. The operation of the central platform 20 will be discussed in detail below with reference to example embodiments of methods according to the present invention.

The local broker 22 may accept and process local orders in a manner similar to that described above in reference to the local broker 30. That is, the local broker 22 may receive orders from local investors and transmit the local orders to the local market center 24 for execution. In addition to local orders, the local broker 22 may accept orders from foreign investors, e.g., the investor 12. Orders originating in the foreign market 110 may be communicated to the local broker 22 by the foreign broker 14 on behalf of the investor 12.

The FX LP 26 is a provider of funds used to convert offshore currency into onshore currency to settle foreign originating trades. The FX LP 26 may provide FX services whereby any party desiring to exchange one form of currency for another may do so at rates specified by the FX LP 26. For example, the FX LP 26 may be a private bank or other financial institution with currency holdings of sufficient volume to exchange USDs for CADs and vice versa when securities are traded.

The FX CCP 28 may perform clearing and settlement services analogous to those performed by the local equity clearing house 32. However, instead of functioning as a counterparty to equities transactions, the FX CCP 28 may be a counterparty to FX transactions. For example, the FX CCP 28 may be configured to receive USDs from or send USDs to the local broker 22 on behalf of the investor 12. The FX CCP 28 may also be configured to receive CADs from or send CADs to the FX LP 26. In this manner, funds for FX transactions need not be transferred directly between the local broker 22 and the FX LP 26.

Exemplary methods for facilitating international securities trading may be performed on a processor of a computer, e.g., a business server located at the central platform 20 or in any other combination of hardware and/or software. According to the example methods, the central platform 20 functions as an intermediary between the local broker 22, the local market center 24, the FX LP 26 and the FX CCP 28.

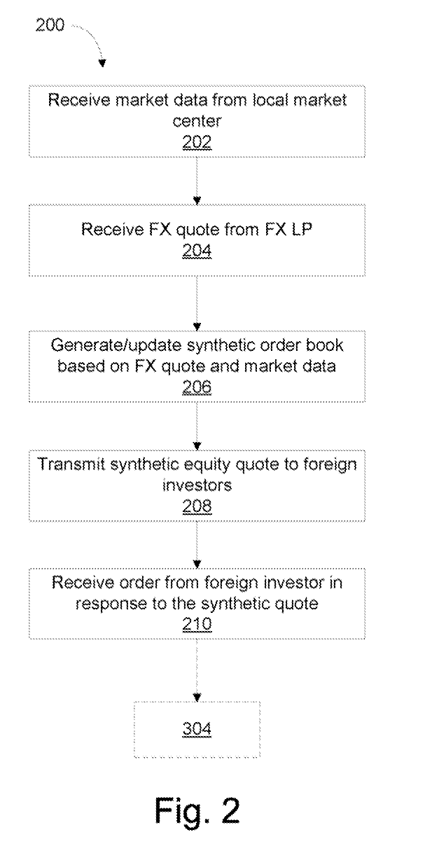

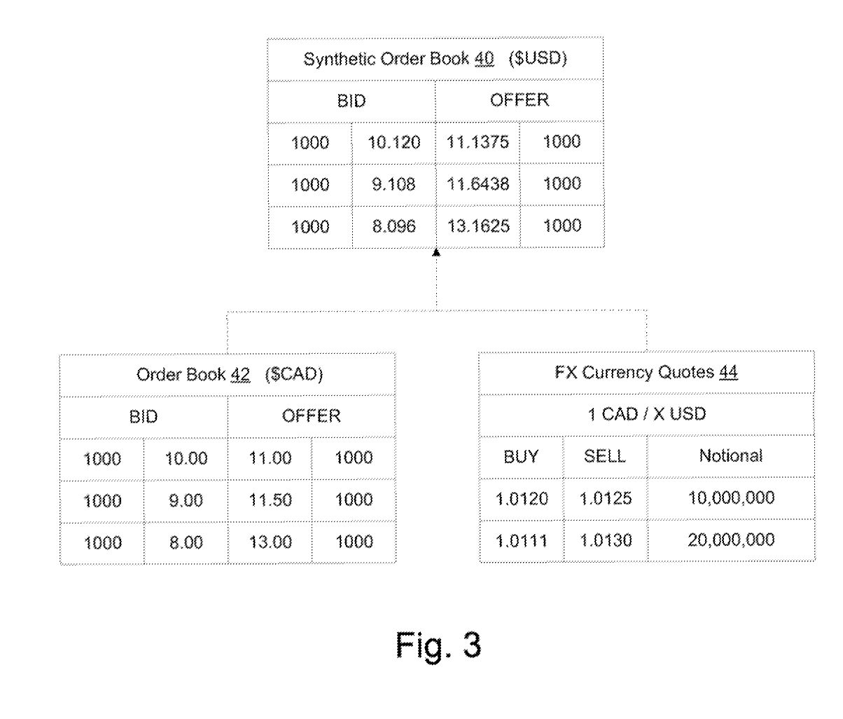

FIG. 2 shows an exemplary method 200 for generating a synthetic quote according to the present invention. As explained below, the synthetic quotes are tradable price quotes generated based on data provided by the local market center 24 and the FX LP 26. In step 202, the central platform 20 may receive market data from the local market center 24. The market data includes bid and offer prices from orders that exist on the order book of the local market center 24. FIG. 3 shows an example embodiment of an order book 42 in which bid and offer prices are specified in CADs. In addition to price, each order in the order book 42 may include a volume to be traded. For example, the top order of the order book 42 specifies a volume of 1,000 shares at a bid price of 10 CADs per share. The top order further specifies a second volume of 1,000 shares at an offer price of 11 CADs per share. The market data may be received in substantially real time or, alternatively, received at predetermined intervals, so that the market data is indicative of the most recent activity at the local market center 24.

In step 204, the central platform 20 may receive an FX quote from the FX LP 26. Referring back to FIG. 3, a set of FX currency quotes 44 may be maintained at the central platform 20 and corresponds to FX rates offered by the FX LP 26 to local or foreign brokers (or in some instances directly to foreign investors) participating in the trading arrangement provided by the central platform 20. The FX rates may be offered on an individual broker or investor basis.

In an example embodiment, the use of an FX quote may be contingent upon the existence of a bi-lateral agreement between the local/foreign broker or investor and the FX LP 26, for example, depending on laws, regulations and/or rules of either of the countries or of the parties involved in the transaction. Thus, in order to take advantage of the FX rates, a local/foreign broker or investor may be required to enter into a bi-lateral agreement with the FX LP 26. Mere participation in the trading arrangement of the central platform 20 does not necessarily indicate the presence of a bi-lateral agreement. For example, a local/foreign broker or investor may have separate agreements with any number of FX LPs.

In the case of an FX CCP that will take on the FX clearing and settlement, there may not be a need for bi-lateral agreements between all counterparties. Instead, all counterparties may have specified trading limits set by the CCP and may require posting of collateral with the CCP.

In an example embodiment, the local broker 22 has an agreement with the FX LP 26, but the local broker 30 is not required to participate in the trading arrangement or have an agreement with the FX LP 26. The central platform 20 may be configured to obtain and store in a database information regarding the requirement for, and/or the existence of any, such agreements (credit relationships) to which the central platform 20 may refer when generating the synthetic quotes. For example, the central platform 20 may match each broker to whom the platform 20 provides a quote to a record in the database and determine respective quotes to be provided to the different brokers.

The FX rates may include a buy rate and a sell rate, similar to the exchange rates provided by typical FX dealers. In order to concretize synthetic foreign securities quotes in local currency units, the FX quotes may also include a notional amount, in addition to the buy and sell rates. A notional amount represents the maximum amount the FX LP 26 is willing to buy/sell at the quoted rates. For example, the top FX quote in the FX currency quote set 44 specifies a buy rate of 1.0120 USDs per CAD, a sell rate of 1.0125 USDs per CAD, and a notional value of 10,000,000 CADs. The buy rate indicates that the FX LP 26 is willing to purchase each CAD for 1.0120 USDs. The sell rate indicates that FX LP 26 is willing to sell each CAD for 1.0125 USDs. According to an example embodiment, the FX LP 26 may have any number of FX quotes pending at any given time. While each row of quotes in quote set 44 has been described as being ascribed to a single respective party, it is noted that the buy side and sell side may be separately sorted according to the best rates. Accordingly, it is possible for the bottom sell rate of quote set 44 to have been received together with the top buy rate of quote set 44. Nevertheless, they are mismatched because the higher the buy rate, the better the buy rate is considered, and the lower the sell rate, the better the sell rate is considered. It further noted that a buy rate may be submitted without a sell rate (or a sell rate for a zero sum) and vice versa.

In step 206, the central platform 20 may generate a synthetic order book or update an existing synthetic order book, e.g., the synthetic order book 40 of FIG. 3. The synthetic order book 40 is generated by converting the market data into USDs based on the best available FX quote. Buy (bid) quotes are converted using the best (highest) buy rate (where “buy rate” refers to the number of local (from the perspective of the investor) currency units (USD) at which a party is willing to buy 1 foreign (from the perspective of the investor) currency unit (CAD)) and offer quotes are converted using the best (lowest) sell rate (where “sell rate” refers to the number of local currency units (USD) at which a party is willing to sell 1 foreign currency unit (CAD)). In the exemplary embodiment shown in FIG. 3, the best buy and sell rates correspond to the top order in the FX quote set 44. The best rate may be determined according to price-time priority so that an older quote is selected over a newer quote when two quotes have the same rates, or via an alternative allocation method such as round robin or pro-rata distribution. Bid prices are converted by multiplying the bid prices by 1.0120 and offer prices are converted by multiplying the offer prices by 1.0125. The synthetic order book 40 may be stored at the central platform 20, e.g., on a computer memory.

In step 208, the central platform 20 may transmit a synthetic equity quote to all participating foreign investors, e.g., the investor 12. The synthetic equity quote may include only a subset of the synthetic order book 40, for example, a bid/offer quote corresponding to the order with the best buy price or best sell price. Any suitably appropriate method of selection from bid/offer quotes, e.g., as in securities market systems, may be used, for example to select a best bid/offer quote.

In an example embodiment, the synthetic equity quote may also specify a list of local brokers who have bi-lateral agreements with the FX LP who provided the rates used to perform the order conversion, e.g., the FX LP 26. In this manner, the investor 12 or the foreign broker 14 may choose amongst the local brokers that have bi-lateral agreements. The synthetic equity quote may be transmitted directly to the investor 12. Optionally, the synthetic equity quote may also be provided to all participating foreign and/or local brokers, e.g., the foreign broker 14 and the local broker 22. Thus, the investor 12 may indirectly receive the synthetic equity quote through the foreign broker 14 or the local broker 22.

In an alternative embodiment, instead of generating the synthetic equity quote based on the best FX quote and providing the investor 12 with a list of local brokers having bi-lateral agreements with the FX LP who provided the best FX quote, the central platform 20 may maintain a list of local brokers associated with each investor and generate the synthetic equity quote based on the best FX quote from an FX LP with whom one of the associated local brokers has a bi-lateral agreement.

In an alternative embodiment, the FX CCP precludes the need for bi-lateral credit relationships as all participants have posted collateral with the CCP. The central platform 20 may provide the synthetic equity quote to all participants based on the best FX rate, where all participants have access to the same rates.

The synthetic equity quote may form the basis for the investor's decision to place an order. In step 210, the central platform 20 may receive an order from the investor 12 in response to the synthetic equity quote. The order may be received at the central platform 20 by first communicating the order to the foreign broker 14, who communicates the order to the local broker 22, who in turn communicates the order to the central platform 20. The order is then processed, e.g., according to the method described below.

Although the method 200 was described as a series of sequential steps, the steps need not occur in the sequence described. FX LPs may submit new FX quotes to the central platform 20 at any time, independent of the receiving of market data from the local market center. Thus, the generation of the synthetic order book at 206 may occur in response to either new market data or new FX quotes, such as when an order is newly placed or executed at the local market center 24.

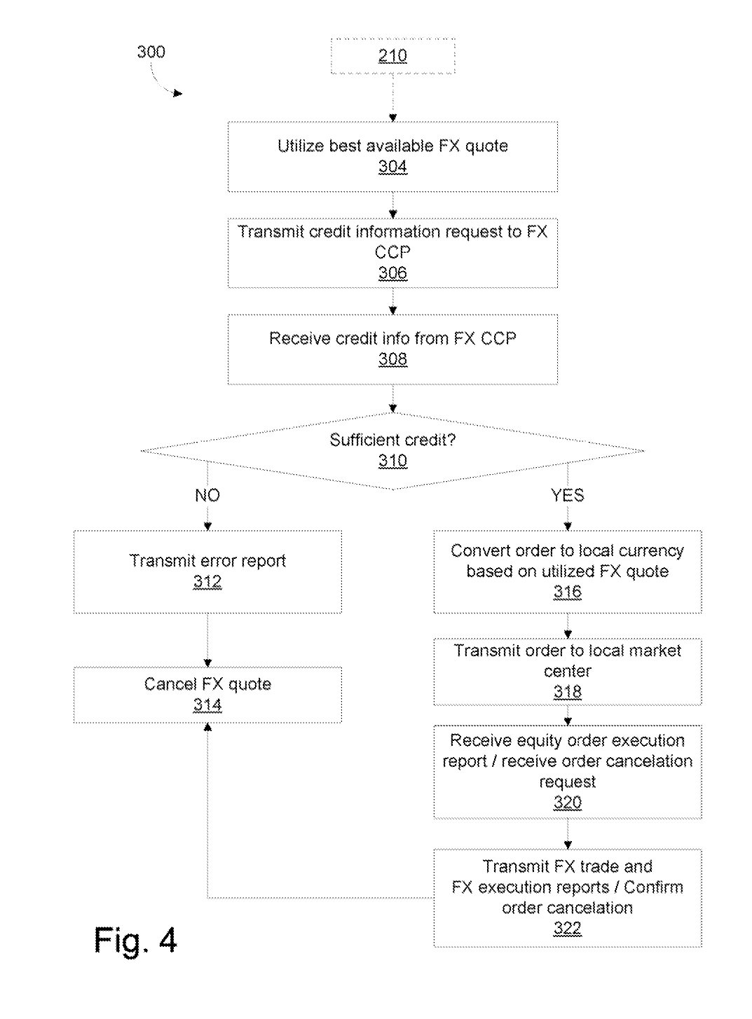

FIG. 4 shows an exemplary embodiment of a method 300 for processing an order according to the present invention. After receiving the order in step 210, a best available FX quote is utilized in step 304. The best available FX quote is not necessarily the same as the FX quote used to perform the order conversion in step 206 of the method 200 to provide the initial equity quote to the foreign investor 12. During a period between the receipt of the synthetic equity quote by the investor 12 and the receipt of the order at the central platform 20, the best available FX quote may change. The original FX quote used to perform order conversion may be canceled or modified, or an FX quote providing better rates may be added. Only an FX quote available for the order at the time the order is actually received by the central platform 20 is utilized.

The utilization of the best available FX quote may be for determining an actual FX rate to be applied. In an example embodiment, the utilization of the FX quote may include locking in of the quote where the central platform 20 disallows modification or cancellation of the FX quote until an outcome related to the order is determined. According to this embodiment, while the FX LP 26 is generally allowed to cancel or modify the price of an FX quote at any time, nevertheless, once the best FX quote is utilized, any requested cancellations or modifications will be queued pending execution, modification or cancellation (by any party which may affect such modification or cancellation) of the order. Locking in also means that if the order is executed, the FX LP is held liable for following through with the FX portion of the order, thereby guaranteeing conversion at the rates specified by the locked in FX quote.

In an example embodiment, the central platform 20 may provide an indication that the FX quote is currently in a utilized, e.g., locked-in, state. The indication may be provided to the FX LP 26 and/or other parties to the order, e.g., the investor 12, the local broker 22 or the foreign broker 14. In other embodiments, no such indication is provided, the lock-in being assumed.

As long as an FX quote is not locked-in, the FX LP 26 is free to modify the price of the FX quote or cancel the FX quote entirely. Additionally, the FX LP 26 may indicate a desire to modify the rate and/or to cancel an FX quote at any time, including while the FX quote is locked-in. However, with respect to a received order, the modification/cancellation will only take place contingent on the outcome of the order. If the order executes successfully, the FX LP 26 will not be able to modify the price or cancel the FX quote as regards the received order.

In an example embodiment, a new FX quote may be considered a requested modification of a previously submitted FX quote. If the previous FX quote has been locked in, the new FX quote may be used for subsequent orders and not the order for which the previous FX quote was locked in. Alternatively, the FX LP 26 may separately provide modifications to prior FX quotes and provide new quotes. According to this embodiment, a modification quote may be used only to the extent the previous quote has not been locked in. Where the previous quote has been locked in, the modification quote is queued as long as the outcome remains unknown for the previously received order.

After utilization of the FX quote, additional processing steps may occur before the FX portion of the order is executed, depending on how the FX market is structured or regulated. For example, FX transactions may go through an FX CCP, e.g., the FX CCP 28, which requires a FX participant, e.g., foreign broker 14 or FX LP 26, to put up collateral before participating in an FX transaction. The FX CCP acts as the counterparty on the other side of the FX transaction opposite the foreign broker 14 or FX LP 26. Execution of the FX transaction may be contingent on a credit limit assigned by the FX CCP. Thus, in step 306, the central platform 20 may transmit a request for credit information to the FX CCP 28.

In step 308, the credit information may be received at the central platform 20 after being transmitted by the FX CCP 28 in response to the credit information request. After receipt, the credit information may be stored in a database and later referred to in the database to determine any transaction limits to be enforced when placing an order.

In an alternative example embodiment, the credit information, e.g., credit limits, may be received at certain times independent of any order. For example, the credit information may be received at the beginning of each trading day. The system may subsequently refer to the previously received credit information for the received orders. Accordingly, steps 306 and 308 may be performed independently of, and prior to, a received order. According to this embodiment, the system may proceed from step 304 to 310, steps 306 and 308 having been previously performed.

In step 310, the central platform 20 may determine whether the FX foreign broker 14 or FX LP 26 has sufficient credit to execute the FX transaction. The stored credit information may be retrieved and analyzed to determine the credit limit of the foreign broker 14 or FX LP 26 and compare the credit limit to the price of the FX transaction, which is calculated based on the utilized FX quote and an estimated final price, since the order has not yet been executed.

If the foreign broker 14 or FX LP 26 does riot have sufficient credit, then the method proceeds to step 312, in which the central platform 20 may transmit an error report to the foreign broker 14 or FX LP 26. The error report may indicate that the foreign broker 14 or FX LP 26 has exceeded its credit limit and therefore cannot participate in the clearing process. The FX quote is canceled at step 314 since it has been determined that the FX transaction cannot be executed due to insufficient credit. If the FX LP has exceeded its credit limit, the central platform 20 may attempt to use the next best FX quote from another FX LP.

If the foreign broker 14 or FX LP 26 has sufficient credit, then the method proceeds to step 316, where the order is converted to local currency based on the utilized FX quote. The conversion may occur in a similar manner to the order conversion previously described in connection with the generation of the synthetic order book. However, instead of converting, for example, CADs into USDs, the conversion is in the opposite direction, i.e., converting the USD specified order price into CADs so that the equity transaction component of the order can be placed with the local market center 24.

In step 318, the central platform 20 may transmit the converted order to the local market center 24, where the order is entered into the central limit order book to await execution.

In step 320, the central platform 20 may receive an equity order execution report from the local market center 24, indicating that the order was matched to another order and executed. The order execution report may also indicate an extent to which the order was executed. If the match was not complete, e.g., the orders may have matched on price but not volume, the order may have been partially executed. However, if the match was complete, then the order will have been executed in its entirety. In an example embodiment, if the order is partially executed, a remaining unexecuted portion of the order may be converted into a new order and transmitted to the local market center 24. Further, a next best FX rate may be utilized, e.g., locked in, dependent on whether the notional value of the current utilized FX quote has been reached. If the notional value has not been reached, then the rates of the current utilized FX quote may be applied to the new order. Otherwise, the next best rate is used.

Alternatively, in step 320, the central platform 20 may receive an order cancellation request, which may be transmitted for example, from the local broker 22. Order cancellation may also occur when the order remains pending for longer than allowed at the local market center 24. For example, all unmatched orders may be removed from the central limit order book after end-of-day trading is concluded.

In step 322, the central platform 20 may, in response to receiving the equity order execution report, transmit FX trade reports and FX execution reports. The FX execution reports may be transmitted to the local broker 22 and the FX LP 26, may function as a confirmation of order execution, and may indicate the final transaction price in USDs. The FX trade reports may be transmitted to the local market center 24, the FX CCP 26 and the local equity clearing house 32, and may include any information necessary to complete clearance and settlement. Together, the FX trade reports and the FX execution reports allow the relevant parties to the order to prepare for the transfer and receipt of funds and other assets associated with the order. The local broker 22 may communicate an indication of successful order execution to the foreign broker 14, who relays the indication to the investor 12. Settlement may be performed using existing exchange methods. For example, the local broker 22 may settle an account with the local market center 24 by paying, in CADs, for shares purchased during the order. Payment may be transferred from the local broker 22 to the local equity clearing house 32.

Alternatively, if the order cancellation request was received in step 320, the central platform 20 may, in step 322, confirm the cancellation with the local broker 22 and/or the local market center 24. In either case, once the order is either executed or canceled, the system and method may proceed to step 314, where the FX quote is canceled or released.

The system may alternatively post limit orders on the exchange and actively manage them, revising the price of the posted limit orders to reflect a change in the FX rate. This process will continue until either the order is executed, or canceled by the originator. The best FX rate will be utilized when the original order is entered, and, for all subsequent revisions, the best prevailing rate will be utilized. When a revised FX rate is entered that will cause a change in the order limit price, a revision request is sent to the exchange. According to the embodiment where the utilized FX rate is locked in, the utilized FX rate will not be released until the outcome of the of the revision is determined, as either the order will be confirmed as having been revised, or the order would have traded before the revision request arrived at the exchange, in which case the utilized FX rate will be applied to the order execution.

As described above, both the equity transaction and the FX transaction involve account settlement amongst parties to the transactions. Settlement for the equity transaction and/or the FX transaction may be conducted with transference of currency and securities using any suitably appropriate channels. For example, exchange may occur between clearing houses, brokers, and investors.

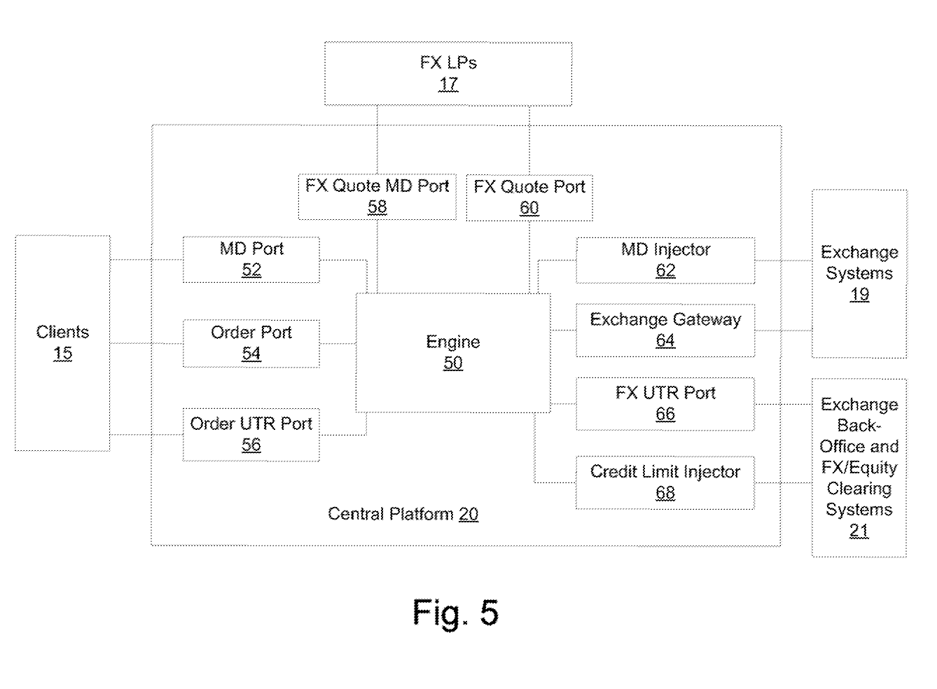

FIG. 5 shows an example embodiment of the central platform 20 according to an example embodiment of the present invention. The central platform 20 may include an engine 50, which controls communication through various communication ports, and which may be hardware and/or software implemented. As shown, the engine 50 may communicate with a set of clients 15, e.g., the investor 12, the foreign broker 14 or the local broker 22, via a market data (MD) port 52, an order port 54, and an order drop copy/unsolicited trade report (UTR) port 56. The engine 50 may communicate with a set of FX LPs 17, e.g., the FX LP 26, via an FX quote MD port 58 and an FX quote port 60. The engine 50 may communicate with exchange systems 19 located at the local market center 24, via an MD injector 62 and an exchange gateway 64. The engine 50 may communicate with exchange back-office and FX and/or equity clearing systems 21, which may include the FX CCP 28 and the local equity clearing house 32, via an FX UTR port 66 and a credit limit injector 68.

The central platform 20 may operate in accordance with the methods 200 and 300 above. For example, the MD port 52 may transmit the synthetic equity quote (step 208). The order port 54 may receive the order (step 210). The order port 54 may also convert the order to CADs based on the utilized FX rate (step 316). The engine 50 may control locking in and releasing of the FX quote (step 304/314). The order UTR port 56 may transmit the FX execution report (step 322). The FX quote MID port 58 may transmit FX quotes to participating FX LPs so that the FX LPs are aware of the quotes being provided by each other. The FX quote port 60 may receive the FX quote from the FX LPs (step 204). The MD injector 62 may receive the market data from the local market center 24 (step 202). The exchange gateway 64 may transmit the order to the local market center 24 (step 318) and receive execution reports from the local market center 24 (step 320). The FX UTR port 66 may transmit the FX trade reports (step 322). The credit limit injector 68 may receive credit information from the local FX CCP 28 (step 308).

As explained in the exemplary embodiments described above, the present invention provides for efficient trading of international securities. For example, the processing of both the FX transaction and the equity transaction centrally saves time. In addition, the present invention provides for enhanced price transparency, since the synthetic equity quotes are reliable indicators of the final trade price. The investor is able to make informed and timely trading decisions because the synthetic equity quotes are provided in the native currency of the investor. In example embodiments, risk exposure is also minimized as to the FX transaction, since the best FX rate is locked in after an order is received. The investor may also benefit by gaining access to a trading channel in which FX transactions occur with fewer or lesser markups compared to typical FX dealers, where the FX LPs are openly competing against each other to provide the best FX rates. Other participants, e.g., the local market center, the local brokers and FX LPs, may also benefit through access to additional revenue sources corresponding to servicing the international orders.

While the above-described example embodiments of the present invention provided for handling of orders specifying a price per share, the system and method may also be applied to facilitate foreign security trading for orders specifying other order parameters instead. For example, an order may specify any one of a notional value, an onshore price, an offshore price, an FX rate, and a share volume, or any combination of such parameters. Referring, for example, to an order specifying a notional amount, an investor may place an order to buy $10,000 USD worth of XYZ Canadian stock. The system may determine when the available share offer volume, CAD offer price, and prevailing FX rate are such that there is $10,000 USD worth of XYZ stock available for purchase, and may execute the transaction when the conditions are met. The FX rate used for the determination may be as described above with respect to the orders specifying a bid price. The system may similarly work on the sell side, where the investor places an order to sell, for example, $10,000 USD worth of XYZ Canadian stock. The system may determine when the available share bid volume, CAD bid price, and prevailing FX rate are such that there is $10,000 USD worth of XYZ stock bid upon, and may execute the transaction when the conditions are met.

According to these examples, the system may, for example, lock in an exchange rate responsive to a later of (a) receipt of the order and (b) receipt of the market data used for determining whether the conditions for execution of the order are met. In an alternative example, the system may lock in the exchange rate upon determination that the received market data and exchange rate are such that the conditions for execution of the order are met. The locked-in rate may be used for converting the currency units where the transaction is successfully executed. If the transaction is unsuccessful, the rate be unlocked without performing the currency conversion.

The various methods described herein may be practiced, each alone, or in various combinations.

An example embodiment of the present invention is directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a hardware computer-readable medium, e.g., as described above, having stored thereon instructions executable by a processor to perform the methods described herein.

An example embodiment of the present invention is directed to a method, e.g., of a hardware component or machine, of transmitting instructions executable by a processor to perform the methods described herein.

Example embodiments of the present invention are directed to one or more of the above-described methods, e.g., computer-implemented methods, alone or in combination.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and appendices. For example, while the system and methods have been described with respect to U.S. and Canadian markets, the methods may be equally applicable to other markets, and modifications of the methods may be implemented to conform with local regulations of the markets to which the methods are applied. Further, a central platform may receive quotes for currency exchange with multiple currencies and create multiple synthetic quotes for the different currencies. Further, steps illustrated in the flowcharts may be omitted and/or certain step sequences may be altered, and, in certain instances multiple illustrated steps may be simultaneously performed.

What is claimed is:

1. A computer-implemented method for facilitating securities trading, comprising:
at least one computer processor performing the following:
receiving market data from a local market center, the market data including a bid price and an offer price from an order at the local market center, the prices being specified using a local currency;
receiving at least one foreign exchange (FX) quote from at least one FX liquidity provider (LP), each FX quote having at least one of a buy rate and a sell rate for converting between the local currency and a foreign currency;
generating a synthetic order book by converting the bid prices into the foreign currency using a best available buy rate and converting the offer prices into the foreign currency using a best available sell rate; and
transmitting a synthetic quote to a foreign investor, the synthetic quote including price information for a best priced order of the synthetic order book.

2. The method of claim 1, further comprising:
receiving a securities order provided on behalf of the foreign investor, the securities order being specified using the foreign currency;
responsive to receiving the securities order, utilizing an FX quote having a buy/sell rate determined to be the best available rate at the time the securities order is received;
converting the securities order into the local currency based on the utilized FX quote;
transmitting the converted securities order to the local market center; and
responsive to receiving an indication of successful execution of the order, transmitting an execution report.

3. The method of claim 2, wherein utilizing the FX quote having the buy/sell rate determined to be the best available rate at the time the securities order is received includes locking in the FX quote having the buy/sell rate determined to be the best available rate at the time the securities order is received, the method further comprising:
releasing the utilized FX quote after whichever occurs of a successful execution of the securities order, a cancellation of the securities order, and a revision of the securities order.

4. The method of claim 2, wherein the transmittal of the converted securities order is conditional upon a determination that an FX liquidity provider participating in an FX transaction component of the securities order has sufficient credit to execute the FX transaction.

5. The method of claim 4, further comprising:
transmitting an error report when it is determined that the FX liquidity provider has insufficient credit to execute the FX transaction.

6. The method of claim 2, wherein utilizing the FX quote having the buy/sell rate determined to be the best available rate at the time the securities order is received includes locking in the FX quote having the buy/sell rate determined to be the best available rate at the time the securities order is received, the method further comprising:
receiving a request to one of modify and cancel the utilized FX quote, wherein the request is queued with respect to the securities order pending a determination of an outcome of the securities order.

7. The method of claim 2, further comprising:
responsive to partial execution of the securities order:
converting a remaining unexecuted portion of the securities order into a new order; and
transmitting the new order to the local market center.

8. The method of claim 1, further comprising:
determining that a local broker does not have an existing agreement with the FX liquidity provider who provided the FX quote having the best available buy/sell rate; and
substituting, for the best buy/sell rate, the next best buy/sell rate for which there exists a bi-lateral agreement between the local broker and the FX liquidity provider who provided the FX quote associated with next best buy/sell rate.

9. The method of claim 1, wherein each FX quote includes a notional value indicating a maximum volume of currency the FX liquidity provider is willing to exchange at the specified buy and sell rates.

10. A system for facilitating securities trading, comprising:
a central computer configured to:
receive market data from a local market center, the market data including a bid price and an offer price from an order at the local market center, the prices being specified using a local currency;
receive at least one foreign exchange (FX) quote from at least one FX liquidity provider (LP), each FX quote having a buy rate and a sell rate for converting between the local currency and a foreign currency;
generate a synthetic order book by converting the bid prices into the foreign currency using a best available buy rate and converting the offer prices into the foreign currency using a best available sell rate; and
transmit a synthetic quote to a foreign investor, the synthetic quote including price information for a best priced order of the synthetic order book.

11. The system of claim 10, wherein the central computer is configured to:
receive a securities order provided on behalf of the foreign investor, the securities order being specified using the foreign currency;
responsive to receiving the securities order, utilize an FX quote having a buy/sell rate determined to be the best available rate at the time the securities order is received;
convert the securities order into the local currency based on the utilized FX quote;
transmit the converted securities order to the local market center; and
responsive to receiving an indication of successful execution of the order, transmit an execution report.

12. The system of claim 11, wherein:
utilization of the FX quote having the buy/sell rate determined to be the best available rate at the time the securities order is received includes locking in the FX quote having the buy/sell rate determined to be the best available rate at the time the securities order is received; and
the central computer is configured to release the utilized FX quote after whichever occurs of a successful execution of the securities order and a cancellation of the securities order.

13. The system of claim 11, wherein the transmittal of the converted securities order is conditional upon a determination that an FX liquidity provider participating in an FX transaction component of the securities order has sufficient credit to execute the FX transaction.

14. The system of claim 13, wherein the central computer is configured to transmit an error report when it is determined that the FX liquidity provider has insufficient credit to execute the FX transaction.

15. The system of claim 11, wherein:
utilization of the FX quote having the buy/sell rate determined to be the best available rate at the time the securities order is received includes locking in the FX quote having the buy/sell rate determined to be the best available rate at the time the securities order is received;
the central computer is configured to receive a request to one of modify and cancel the utilized FX quote; and
the request is queued with respect to the securities order pending a determination of an outcome of the securities order.

16. The system of claim 11, wherein the central computer is configured to:
responsive to partial execution of the securities order:
convert a remaining unexecuted portion of the securities order into a new order; and
transmit the new order to the local market center.

17. The system of claim 10, wherein the central computer is configured to:
determine that a local broker does not have an existing agreement with the FX LP who provided the FX quote having the best available buy/sell rate; and
substitute, for the best buy/sell rate, the next best buy/sell rate for which there exists a bi-lateral agreement between the local broker and the FX LP who provided the FX quote associated with next best buy/sell rate.

18. The system of claim 10, wherein each FX quote includes a notional value indicating a maximum value of currency the FX LP is willing to exchange at the specified buy and sell rates.

19. A hardware-implemented computer-readable storage medium having stored thereon a series of instructions executable by a processor of a security transaction-assisting machine, the instructions which, when executed, cause the processor to perform a method, the method comprising:
receiving market data from a local market center, the market data including a bid price and an offer price from an order at the local market center, the prices being specified using a local currency;
receiving at least one foreign exchange (FX) quote from at least one FX liquidity provider (LP), each FX quote having a buy rate and a sell rate for converting between the local currency and a foreign currency;
generating a synthetic order book by converting the bid prices into the foreign currency using a best available buy rate and converting the offer prices into the foreign currency using a best available sell rate; and
transmitting a synthetic quote to a foreign investor, the synthetic quote including price information for a best priced order of the synthetic order book.

20. The storage medium of claim 19, the method further comprising:
receiving a securities order on behalf of the foreign investor, the securities order being specified using the foreign currency;
responsive to receiving the securities order, utilizing an FX quote having a buy/sell rate determined to be the best available rate at the time the securities order is received;
converting the securities order into the local currency based on the utilized FX quote;
transmitting the converted securities order to the local market center; and
responsive to receiving an indication of successful execution of the order, transmitting an execution report.

21. A computer-implemented method for facilitating securities trading, comprising:
one or more computer processors performing the following:
obtaining market data including at least one price quote expressed according to a first currency;
obtaining an exchange rate quote for converting a number of units of the first currency into a number of units of a second currency;
based on the exchange rate quote, modifying the price quote for expression according to the second currency; and
transmitting the modified price quote for output at an investor device.

22. The method of claim 21, further comprising:
responsive to the receipt of an order, the one or more computer processors locking in one of the obtained exchange rate quote and a new exchange rate quote for a pendency of the order.

23. A computer-implemented method for facilitating securities trading, comprising:
one or more computer processor performing the following:
receiving an exchange rate quote for converting a number of units of a first currency into a number of units of a second currency;
while the received exchange rate quote is open, receiving an order specifying value units expressed according to one of the first and second currencies; and
responsive to receipt of the order:
locking in the exchange rate quote for the pendency of the order;
converting the received order into a modified order specifying value units expressed according to the other of the first and second currencies; and
transmitting the modified order for execution.

24. A computer-implemented method for facilitating securities trading, comprising:
one or more computer processors performing the following:
obtaining one or more market quotes regarding an asset, each specifying (a) a respective price expressed according to a first currency and (b) a respective number of shares;
obtaining an order regarding the asset specifying a number of units of a second currency;
obtaining an exchange rate quote for converting a number of units of the first currency into a number of units of the second currency;
based on the one or more market quotes and the exchange rate quote, determining whether there are available a sufficient quantity of the asset for a position opposite to that of the order to execute the order at the specified number of second currency units; and
executing the order responsive to a positive result of the determining step.

25. The method of claim 24, wherein the order is executed at the obtained exchange rate.

26. The method of claim 25, further comprising:
locking in the exchange rate quote at least upon the positive result of the determining step;
converting a number of units of the first currency into a number of units of the second currency at the locked in exchange rate quote after successful execution of the order; and
releasing the exchange rate quote after unsuccessful execution of the order.
